(19) United States
(12) Patent Application Publication
(10) Pub. No.: US 2014/0152601 A1
(43) Pub. Date: Jun. 5, 2014

(54) TOUCH DISPLAY DEVICE AND CONTROL METHOD THEREOF

(71) Applicant: HON HAI PRECISION INDUSTRY CO., LTD., New Taipei (TW)

(72) Inventor: KUO-WEI HUNG, New Taipei (TW)

(73) Assignee: HON HAI PRECISION INDUSTRY CO., LTD., New Taipei (TW)

(21) Appl. No.: 14/092,899

(22) Filed: Nov. 27, 2013

(30) Foreign Application Priority Data
Dec. 3, 2012 (TW) 101145312

(51) Int. Cl. G06F 3/041

(52) U.S. Cl. CPC G06F 3/041
USPC 345/173

(57) ABSTRACT

A touch display device includes a display, a touch panel, a storage, a touch driver, and a processor. The display displays a graphical user interface (GUI). The touch panel senses a touch operation. The touch driver defines a valid operation area of the touch panel according to the GUI and obtains information of touch operations applied to the touch panel. When a location of the touch operation is located within the valid operation area, the touch driver generates a touch signal. When a location of the touch operation is not located within the valid operation area, the touch operation is determined to be an invalid touch operation, and the touch driver does not generate a touch signal.

### BACKGROUND

1. Technical Field

The present disclosure relates to a touch display device and a control method of the touch display device.

2. Description of Related Art

Touch display devices, such as smart phones, provide a graphical user interface (GUI) having a plurality of touchable items, such as application icons. However, certain areas of the GUI may not be touchable, such as an edge area of the GUI. When the edge area is touched, a touch driver of the touch display device still obtains touch data and transmits the touch data to a processor of the touch display device, and the processor still analyzes and processes the touch data. Thus, power consumption of the processor is increased.

Therefore, what is needed is a means to overcome the above-described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram of an exemplary embodiment of a touch display device.

FIG. 2 shows an embodiment of a graphical user interface of the touch display device of FIG. 1.

FIG. 3 is a flowchart of one embodiment of a control method of the touch display device of FIG. 1.

### DETAILED DESCRIPTION

Reference will be made to the drawings to describe various embodiments.

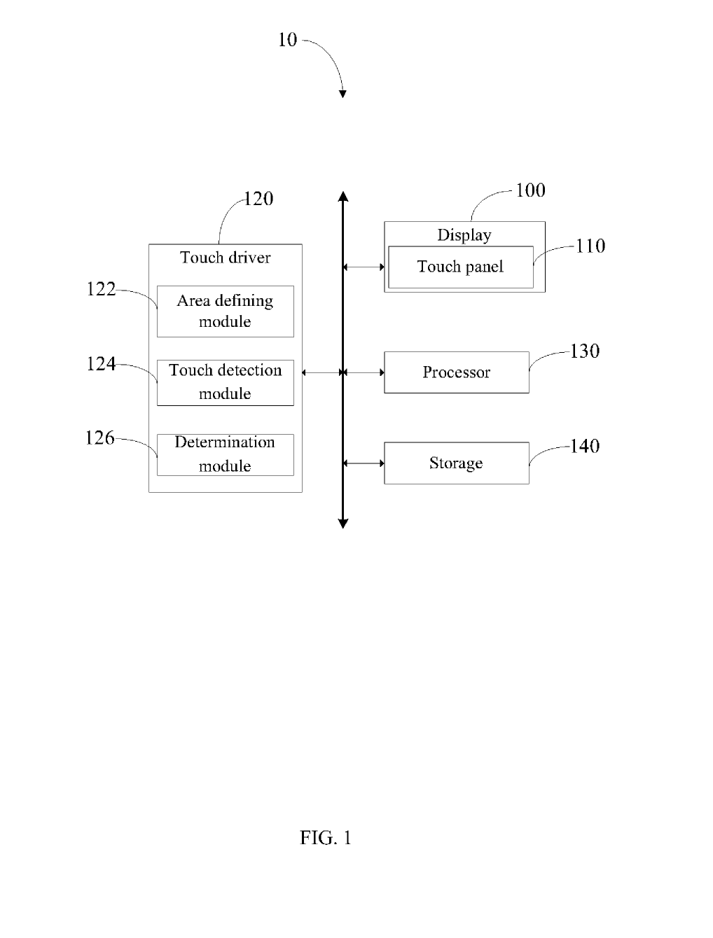

FIG. 1 is a schematic block diagram of an exemplary embodiment of a touch display device 10. The touch display device 10 includes a display 100 and a touch driver 120, a processor 130, and a storage 140. The display 100 includes a touch panel 110. The touch display device 10 can be, but is not limited to being, a smart phone, a mobile internet device (MID), or other similar device. FIG. 1 is just one example of the touch display device 10, and the touch display device 10 can include more or fewer components than those shown in the embodiment, or have a different configuration of the components. The touch panel 110 senses a touch operation on the display 100. In the embodiment, the touch panel 110 can be a capacitive touch panel or a resistive touch panel, for example.

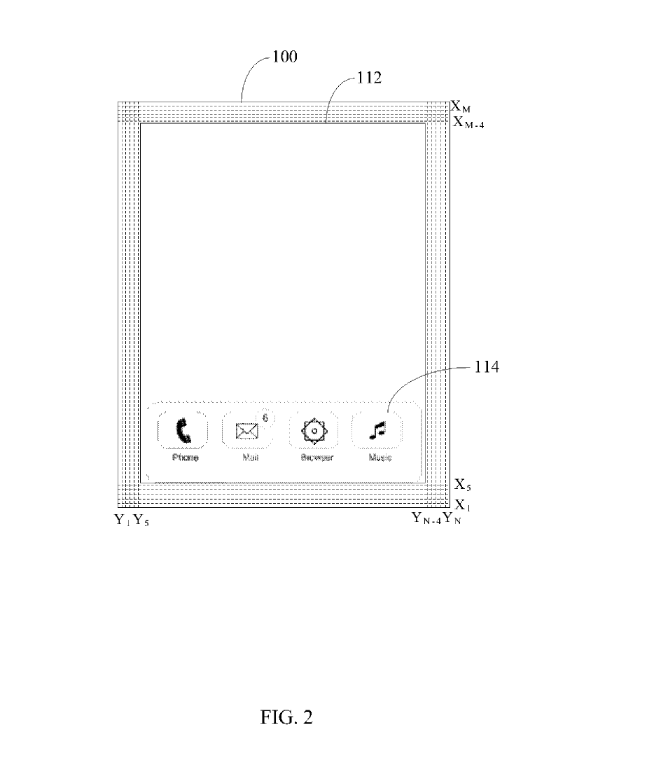

FIG. 2 shows a graphical user interface (GUI) 112 of the touch display device 10. The touch panel 110 includes a plurality of scanning lines Xi(1≦i≦M, M is a natural number) to sense a first coordinate of a touch operation applied to the touch panel 110, and a plurality of sensing lines Yj(1≦j≦N, N is a natural number) to sense a second coordinate of the touch operation. The GUI 112 includes a plurality of touchable items (e.g., icons or texts) 114, and each touchable item 114 corresponds to a function or an application of the touch display device 10. When one touchable item 114 is touched, a corresponding function or application of the touch display device 10 is activated.

The touch driver 120 defines a valid operation area according to the GUI 112 displayed on the display 100 and obtains information of the touch operation applied to the touch panel 110. In the embodiment, the touch driver 120 includes an area defining module 122, a touch detection module 124, and a determination module 126. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The area defining module 122 defines the valid operation area according to attribute information of the GUI 112. In detail, the attribute information includes a size and coordinates of four endpoints of the GUI 112 on the display 100 which four connection lines between the four endpoints form four edges of the GUI 112 and a location of each touchable item 114 on the GUI 112. The area defining module 122 first determines two scanning lines (e.g., X₅ and X_{M-4}) and two sensing lines (e.g., Y₅ and Y_{N-4}) corresponding to four edges, respectively, of the GUI 112 according to the attribute information of the GUI 112. Then, a rectangular area surrounded by the two scanning lines and the two sensing lines is determined to be the valid operation area.

The touch detection module 124 detects the touch operation applied to the touch panel 110 and obtains information, such as a type and a location of the touch operation. The type of the touch operation can be a single-tap touch, a multiple-tap touch, or a sliding touch.

The determination module 126 determines whether the touch operation is within the valid operation area. When the touch operation is not located within the valid operation area, the touch operation is determined to be an invalid touch operation, and no touch signals are generated. When the touch operation is within the valid operation area, the touch operation is determined to be a valid touch operation. Then, the touch determination module 126 generates a touch signal according to the touch operation and sends the touch signal to the processor 130.

The processor 130 performs corresponding functions according to the received touch signals.

The storage 140 stores the attribute information of the GUI 112, the touchable items 114, the programs and/or applications corresponding to the touchable items 114, and other information of the touch display device 10. The storage 140 can be a flash memory, a read only memory, a hard disk drive, or other similar device.

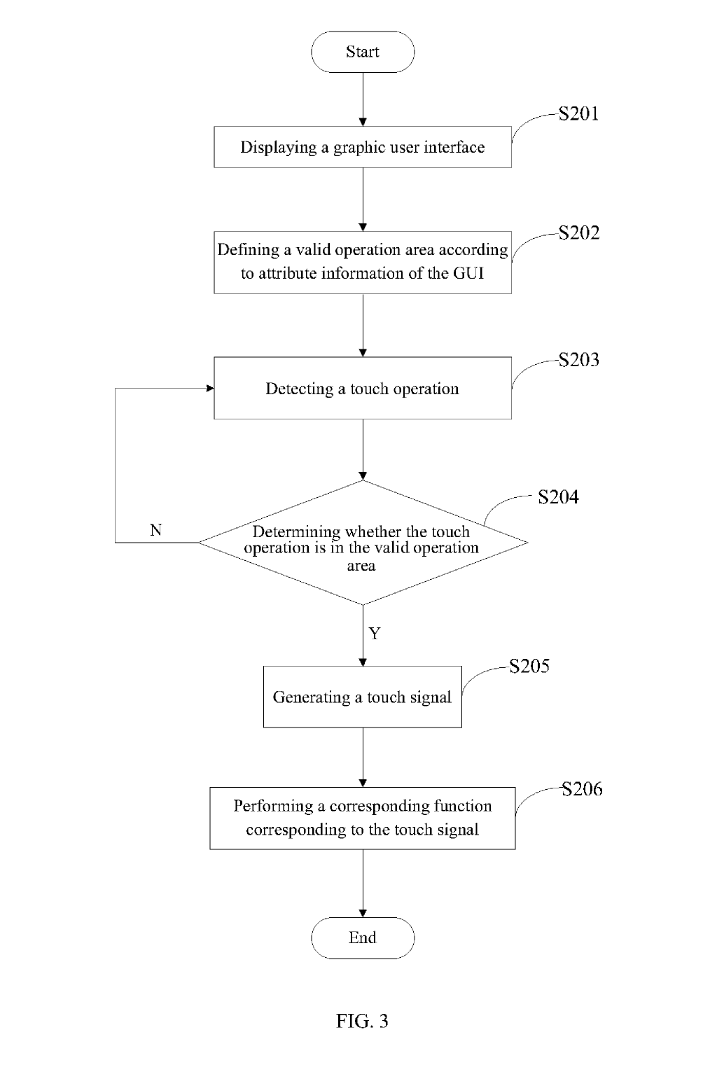

FIG. 3 shows a flowchart of one embodiment of a control method of the touch display device 10. Depending on the embodiment, additional steps may be added, others removed, and the ordering of the steps may be changed.

In step S201, the display 100 displays a GUI 112. The GUI 112 includes a plurality of touchable items 114, and each touchable item 114 corresponds to a function or an application of the touch display device 10.

In step S202, the area defining module 122 defines a valid operation area according to the GUI 112 displayed on the display 100 and obtains information of a touch operation applied to the touch panel 110. Details of defining the valid operation area are provided above.

In step S203, the touch detection module 124 detects a touch operation applied to the touch panel 110.

In step S204, the determination module 126 determines whether the detected touch operation is within the valid operation area. When the touch operation is not within the valid operation area, the touch operation is determined to be an invalid touch operation, and step 203 is repeated. When the touch operation is within the valid operation area, step S205 is performed.

In step 205, the determination module 126 generates a touch signal according to the touch operation.

In step 206, the processor 130 controls the touch display device 100 perform a corresponding function according to the received touch signal.

In summary, the control method for the touch display device 10 sets a valid operation area corresponding to the graphic user interface. When a detected touch operation in not located within the valid operation area, the processor will not receive the touch data of the touch operation. Thus, the processor processes less data and consumes less power.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A touch display device, comprising:
a display displaying a graphic user interface (GUI);
a touch panel;
a processor; and
a touch driver comprising a plurality of software programs, the plurality of software programs comprising:
an area defining module defining a valid operation area according to the GUI;
a touch detection module detecting a touch operation applied to the touch panel and obtaining information of the touch operation;
a determination module determining whether the touch operation is within the valid operation area, and sending a touch signal to the processor when the touch operation is located within the valid operation area; and when the touch operation is not within the valid operation area, no touch signals are generated.

2. The touch display device of claim 1, wherein the GUI comprises a plurality of touchable items, each touchable item corresponds to a function or an application of the touch display device; when one of the touchable items is touched, a corresponding function or application of the touch display device is activated.

3. The touch display device of claim 2, further comprising a storage storing attribute information of the GUI, the touchable items, and applications corresponding to the touchable items.

4. The touch display device of claim 3, wherein the attribute information comprises coordinates of four endpoints of the GUI on the display which four connection lines between the four endpoints form four edges of the GUI and a location of each touchable item on the GUI.

5. The touch display device of claim 4, wherein the touch panel comprises a plurality of scanning lines Xi(1≦i≦M, M is a natural number) to sense a first coordinate of the touch operation and a plurality of sensing lines Yj(1≦j≦N, N is a natural number) to sense a second coordinate of the touch operation.

6. The touch display device of claim 5, wherein the valid operation area is determined by:
determining two scanning lines and two sensing lines corresponding to four edges, respectively, of the GUI according to the size of the GUI; and
determining a rectangular area surrounded by the two scanning lines and the two sensing lines, where the rectangular are is determined to be the valid operation area.

7. The touch display device of claim 1, wherein a type of the touch operation comprises a single-tap touch, a multiple-tap touch, and a sliding touch.

8. A control method of a touch display device, comprising:
displaying a graphic user interface (GUI) on a display of the touch display device;
defining a valid operation area according to attribute information of the GUI;
detecting a touch operation applied to a touch panel of the touch display device;
determining whether the touch operation is located within the valid operation area; sending a touch signal to a processor of the touch display device when the touch operation is located within the valid operation area; and
when the touch operation is not located within the valid operation area, detecting step is repeated.

9. The control method of claim 8, further comprising performing a corresponding function corresponding to the touch signal.

10. The control method of claim 8, wherein in the step of defining a valid operation area comprising: determining two scanning lines and two sensing lines corresponding to four edges, respectively, of the GUI according to the attribute information of the GUI; and determining a rectangular area surrounded by the two scanning lines and the two sensing lines, where the rectangular are is determined to be the valid operation area.

11. The control method of claim 8, wherein the attribute information includes a size, a position of the GUI, and a position of each touchable item on the GUI.
